(19) United States
(12) Patent Application Publication
(10) Pub. No.: US 2026/0295362 A1
(43) Pub. Date: Oct. 1, 2026

(54) SELF-PROPELLING VEHICLE FOR EXERCISE

(71) Applicant: Nankang Health Tech CO., LTD., Taipei City (TW)

(72) Inventor: TZU-JEN CHEN, Taipei City (TW)

(21) Appl. No.: 19/096,660

(22) Filed: Mar. 31, 2025

(51) Int. Cl. A63B 71/00; A61G 5/10; A63B 22/06

(52) U.S. Cl. CPC A63B 71/0009; A61G 5/1051; A63B 22/0605; A63B 2071/0018

(57) ABSTRACT

A self-propelling vehicle for exercise includes a frame assembly, a seat element, two moving front wheels, a drive pedal, at least one steering rear wheel, a protective cover, an operation assembly, and a switching assembly. The operation assembly includes an operating member, a first transmission axle, a connection member, and a second transmission axle. The switching assembly includes a positioning portion and an adjustment member. The user may sit on the seat element to control the moving front wheels to move forward by stepping on the drive pedal and may use the operating member of the operation assembly to drive the steering rear wheel for steering to exhibit a relatively small rotation radius for easy steering and may use the design of the connection member to allow the first transmission axle to selectively drive the second transmission axle through the adjustment member of the switching assembly.

### BACKGROUND OF THE INVENTION

### a Technical Field of the Invention

The present invention provides a self-propelling vehicle for exercise that utilizes rear wheel steering to improve steering flexibility and enables the rear wheel to switch between stem control and free rotation modes, thereby taking into account the control performance of both riding and pushing.

### b Description of the Prior Art

Currently, there are multi-purpose bicycles available on the market that can be used for exercise, riding, rehabilitation, and transportation and usually have the characteristics of both pedal driving and wheelchair pushing, and are suitable for people with limited mobility or users who need rehabilitation training. However, existing designs still have many technical defects, which affect their convenience and flexibility in actual use.

Firstly, most of the vehicles of this type are designed based on wheelchairs, having a relatively large vehicle body width, which limits their maneuverability in narrow spaces or when making sharp turns. For example, they are difficult to turn due to a large turning radius, or their stability is affected by the inner wheel difference. This is especially true in scenarios where frequent turns are required, such as indoor walkways or crowded venues. Traditional designs are difficult to meet flexibility requirements.

Secondly, the vehicles of this type usually have both self-operation and caregiver-pushing functions. However, the stems of existing vehicles are mostly designed to be operated only by the user. When the caregiver pushes the vehicle, the direction cannot be controlled through the stem, making it difficult to adjust the direction of the vehicle in the push mode. Even if the caregiver can still push the vehicle forward, the direction control is not flexible and the steering is difficult, which reduces the convenience and safety of pushing.

Some improved designs attempt to improve steering performance by increasing the number of wheels or adopting a flexible frame structure, but such solutions are often accompanied by problems of increased vehicle weight and structural complexity. If the all-wheel steering function is introduced, although it can solve the turning radius and direction control problems of the push mode, the all-wheel steering design will cause the user to be unable to accurately control the direction through the stem in the pedaling mode, thus affecting the normal operation of the pedaling mode. This has become a major bottleneck of the existing technology.

### SUMMARY OF THE INVENTION

The primary objective of the present invention is to introduce a rear wheel steering system to use the operation assembly to drive the steering rear wheel, reduce the turning radius, improve operational flexibility, and use the design of a connection member and an adjustment member to enable the rear wheel to switch between stem control and free rotation modes, while taking into account the control performance of riding and pushing.

The structure of the present invention comprises: a frame assembly, a seat element, two moving front wheels, a drive pedal, at least one steering rear wheel, a protective cover, an operation assembly, and a switching assembly, wherein the operation assembly comprises an operating member, a first transmission axle, a connection member, and a second transmission axle; the switching assembly comprises a positioning portion and an adjustment member, wherein the seat element is mounted on the frame assembly, and the moving front wheels are arranged on two sides of the seat element, and the drive pedal is connected to and drives the moving front wheels, and the steering rear wheel is arranged at one side of the frame assembly opposite to the drive pedal, and the protective cover is pivotally connected to a top of the steering rear wheel for steering in synchronization therewith, and the operation assembly is connected to the protective cover to operate the steering rear wheel, and the operating member is controllable by the user, and the first transmission axle is pivotally disposed in the frame assembly, and the connection member is fixed on one end of the first transmission axle and drivable by the operating member, and one end of the second transmission axle is pivotally arranged at one side of the first transmission axle, and another end is fixed to the protective cover, and the adjustment member corresponds to and is engageable with the positioning portion.

Generally, the user can sit on the seat component and control the moving front wheel to move forward by stepping on the driving pedal, and use the operating member of the operation assembly to drive the steering rear wheel to turn to thereby exhibit a smaller rotation radius for being easy to steer, and the design of the connection member can be used to allow the first transmission axle to selectively drive the second transmission axle. When the adjustment member of the switching assembly is in engagement with the positioning portion, the second transmission axle and the first transmission axle can rotate synchronously to present a stem control mode, or when the adjustment member is separated from the positioning portion, the second transmission axle can rotate freely, so that the protective cover and the steering rear wheel can rotate freely, which is convenient for the caregiver to push. The whole can be conveniently used for multiple purposes, such as sports, riding, rehabilitation, and walking.

By using the above technology, the problems of conventional multi-purpose bicycles, such as too large turning radius, difficulty in turning, and stem being at the front, which makes it difficult for the care-giving pusher to control, can be overcome, thus achieving the above advantages and practical progress.

### BRIEF DESCRIPTION OF THE DRAWINGS

FIG. 1 is a perspective view showing a first embodiment of the present invention.

FIG. 2 is a perspective view, taken from a different angle, showing the first embodiment of the present invention.

FIG. 3 is a schematic view showing an operation assembly of the first embodiment of the present invention.

FIG. 4 is a schematic view showing rear wheel steering according to the first embodiment of the present invention.

FIG. 5 is a schematic view showing rear wheel switching according to the first embodiment of the present invention.

FIG. 6 is a schematic view showing pushing according to the first embodiment of the present invention.

FIG. 7 is a schematic view showing rear wheel switching according to a second embodiment of the present invention.

FIG. 8 is an exploded view of a third embodiment of the present invention.

FIG. 9 is a schematic view showing seat adjusting according to the third embodiment of the present invention.

### DETAILED DESCRIPTION OF THE PREFERRED EMBODIMENTS

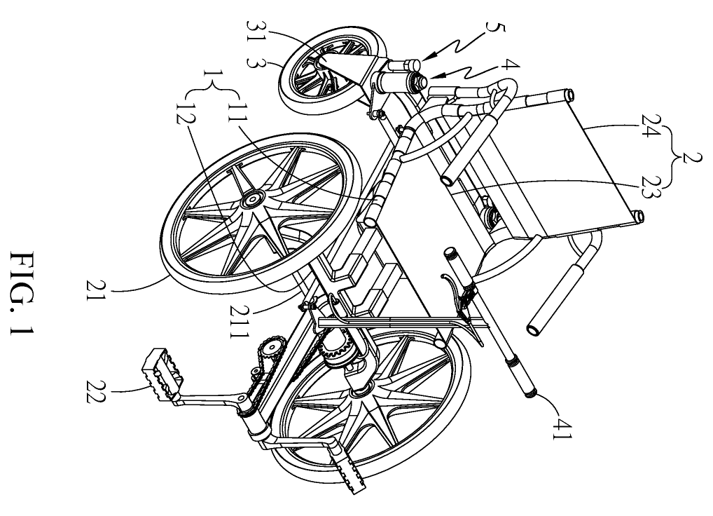

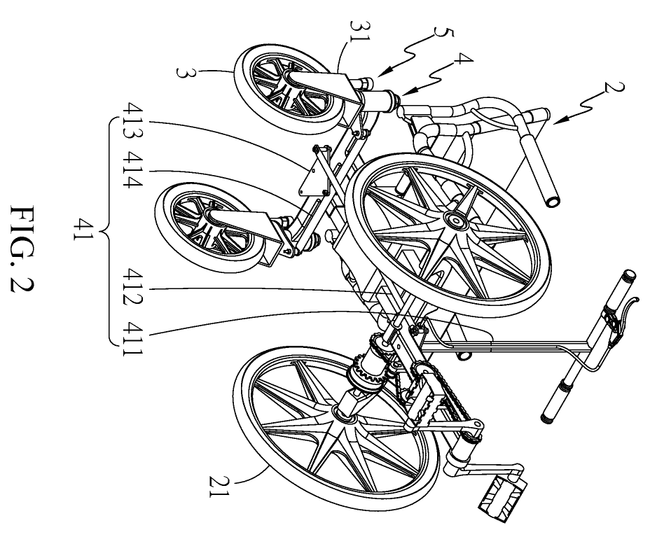

As shown in FIGS. 1-3, the present invention comprises:

a frame assembly 1;

a seat element 2, which is arranged on the frame assembly 1;

two moving front wheels 21, which are arranged on two sides of the seat element 2;

a drive pedal 22, which is connected to and drives each of the moving front wheels 21;

at least one steering rear wheel 3, which is arranged on one side of the frame assembly 1 opposite to the drive pedal 22;

a protective cover 31, which is pivotally connected to a top of the steering rear wheel 3 for steering in synchronization therewith;

an operation assembly 4, which is connected to the protective cover 31 to operate the steering rear wheel 3 to carry out change of a moving direction, wherein the operation assembly 4 comprises an operating member 41 controllable by a user, at least one first transmission axle 42 pivotally disposed in the frame assembly 1, a connection member 43 fixed on one end of the first transmission axle 42 and drivable by the operating member 41, and a second transmission axle 44, wherein one end of the second transmission axle 44 is pivotally arranged at one side of the first transmission axle 42, and another end is fixed to the protective cover 31; and

at least one switching assembly 5, which is arranged on one side of the connection member 43 and comprises a positioning portion 51 and an adjustment member 52 corresponding to and engageable with the positioning portion 51, so as to have the second transmission axle 44 and the first transmission axle 42 rotating synchronously when engaging with the positioning portion 51 and to have the second transmission axle 44 rotating freely when disengaging from the positioning portion 51.

The adjustment member 52 includes an elastic element 521 arranged thereon to apply an elastic force to enhance the state of engagement of the positioning portion 51 with the adjustment member 52, and includes, on one side of the connection member 43, a collar portion 431 for mounting the adjustment member 52 in a movable manner, wherein the collar portion 431 includes two engagement notch portions 432, and the adjustment member 52 includes a protrusion portion 522 engageable with each individual one of the engagement notch portions 432.

The frame assembly 1 is a metal frame, which comprises a seat frame 11 for mounting the seat element 2 and a wheel frame 12 for mounting the moving front wheels 21 and the steering rear wheel 3. The seat element 2 comprises a seat portion 23 mounted on the seat frame 11 and a back support portion 24 arranged on the seat frame 11 and located at one side of the seat portion 23. In the instant embodiment, the seat portion 23 and the back support portion 24 are mounted on the seat frame 11 by elastic bands. The two moving front wheels 21 are commonly rotatably mounted on a driving axle 211 and are respectively located on two sides of the wheel frame 12. The drive pedal 22 is rotatably mounted to a portion of the wheel frame 12 that is extended frontwards and is located at a front side of the seat portion 23 and includes a pedal that is commonly used in bicycles. The number of the steering rear wheel 3 is two that are rotatably mounted to a portion of the wheel frame 12 that is extended rearwards and are located at a rear side of the seat portion 23 as an example for illustration and are synchronously oscillateable by means of a steering connection rod 412 and a triangular rocker arm 413. The protective cover 31 is arranged as an inverted U-shaped plate mounted on the top of the steering rear wheel 3 as an example for illustration and has two ends that are pivotally connected to a center axle of the steering rear wheel 3 and an upper surface that is fixed to the second transmission axle 44. The operation assembly 4 is defined as a transmission structure connecting from the stem 411 to the steering rear wheel 3, and thus, the operating member 41 of the operation assembly 4 refers to a combination of the T-shaped stem 411, the steering connection rod 412, the rocker arm 413, and the drive bar 414. Similar to the steering rear wheel 3, the number of the first transmission axle 42 is also two. As an example for illustration, the first transmission axle 42 and the second transmission axle 44 are arranged in a longitudinal direction on the steering rear wheel 3. The first transmission axle 42 is fixedly fastened to the connection member 43, and the second transmission axle 44 is fixedly fastened to the protective cover 31, and the means for fastening can be one of bolt fixing, clamp fixing, adhesive fixing, or welding fixing. As an example for illustration, the connection member 43 is a plate arranged between the first transmission axle 42 and the second transmission axle 44, and being arranged between two axles means operational coupling, and also includes a positional relationship as an example for illustration in the instant embodiment. The switching assembly 5 is a clamp buckle, a press buckle, or a plug buckle structure, and in the instant embodiment, the plug buckle structure is taken as an example for illustration, wherein the positioning portion 51 is a recess or a through hole, and a recess integrally formed in the protective cover 31 is taken as an example for illustration in the instant embodiment, and a movable plug pin arranged on the connection member 43 is taken as an example of the adjustment member 52. A tension spring disposed in the collar portion 431 is taken as an example for illustrating the elastic element 521. As an example of illustration, the engagement notch portions 432 are two notches of different depths formed in an end of the collar portion 431. As an example of illustration, the protrusion portion 522 is a rib formed on a side of the adjustment member 52.

As shown in FIGS. 1-6, the frame assembly 1 of the present invention has an outside appearance that is generally of a configuration of wheelchair and is made up of the seat portion 23, the back support portion 24, the moving front wheels 21, and the steering rear wheels 3; however, as multiple ways of use, such as sports, riding, rehabilitation, and walking, are included, the drive pedal 22 and the operation assembly 4 are additionally provided. Of course, the overall outside appearance is not necessarily a configuration of wheelchair, and for example, the seat element 2 may only include the seat portion 23 and does not include the back support portion 24. The provision of the back support portion 24 allows the user to ride more comfortably and safely, and does not affect the implementation of subsequent functions.

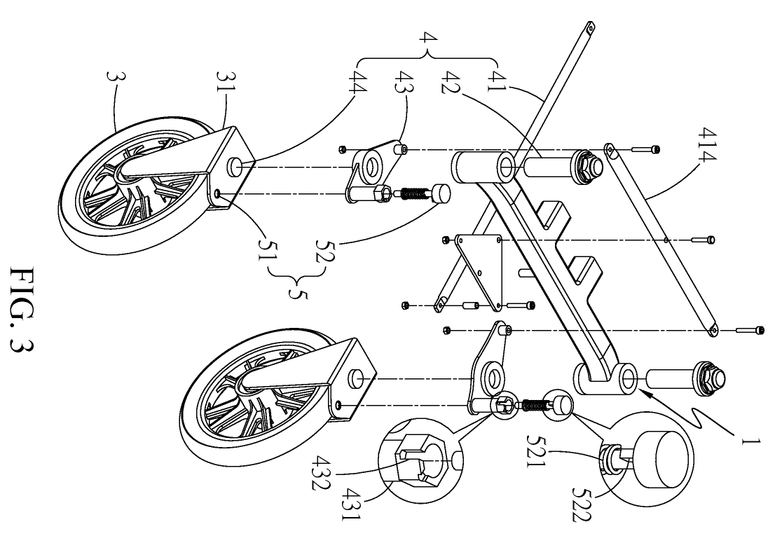

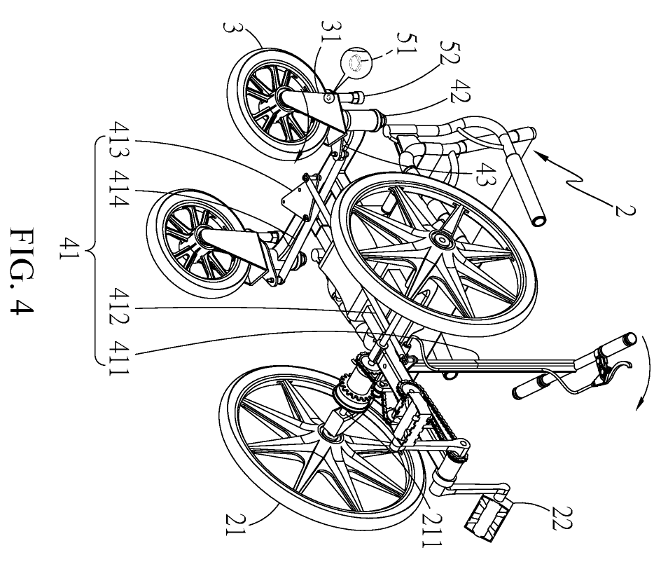

As shown in FIGS. 3-4, the user uses the present invention for riding or sports, the user can sit on the seat element 2 and steps on the drive pedal 22 to drive the driving axle 211 so as to control the moving front wheels 21 to move forward, and uses the stem 411 of the operating member 41 to sequentially drive the steering connection rod 412, the rocker arm 413, the drive bar 414, the connection members 43, the first transmission axles 42, the second transmission axles 44, the protective covers 31, and the steering rear wheels 3 so as to achieve the purpose of steering with the steering rear wheels 3, wherein for the part that the operating member 41 drives the steering connection rod 412, the rocker arm 413, and the drive bar 414, this is generally the mechanism that a steering wheel controls the front wheels of a four-wheel vehicle for turning synchronously, and the operation process thereof will not be described in detail herein, and under the stem 411 control mode that the adjustment members 52 are in engagement with the positioning portions 51, the ends of the drive bar 414 are pivotally connected to the connection members 43 and drive the connection members 43 to oscillate, and as the first transmission axles 42 are rotatably mounted within the frame assembly 1, when the connection members 43 are rotating about centers defined by the first transmission axles 42, the frame assembly 1 may impose constraint to the first transmission axles 42 so as not to get skewed due to being pulled by the drive bar 414. Further, since the positioning portions 51 provided on the protective covers 31 and the adjustment members 52 provided on the connection members 43 are in a state of being fixed together, the connection members 43, when pulled by the drive bar 414, may drive, through the switching assemblies 5, the protective covers 31 to rotate. As the protective covers 31 are directly pivoted to the tops of the steering rear wheels 3, driving the protective covers 31 to move is equivalent to driving the steering rear wheels 3 to move, so that the purpose of rear wheel steering by using the operating member 41 to control the steering rear wheels 3 can be achieved. This design of rear wheel steering has a smaller turning radius, making it easier for the user to make large turns and not limited by the size of the vehicle or a narrow environment.

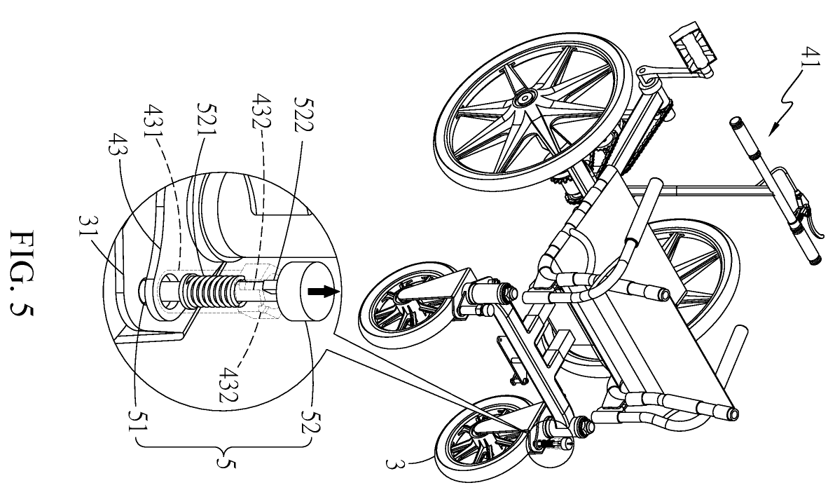

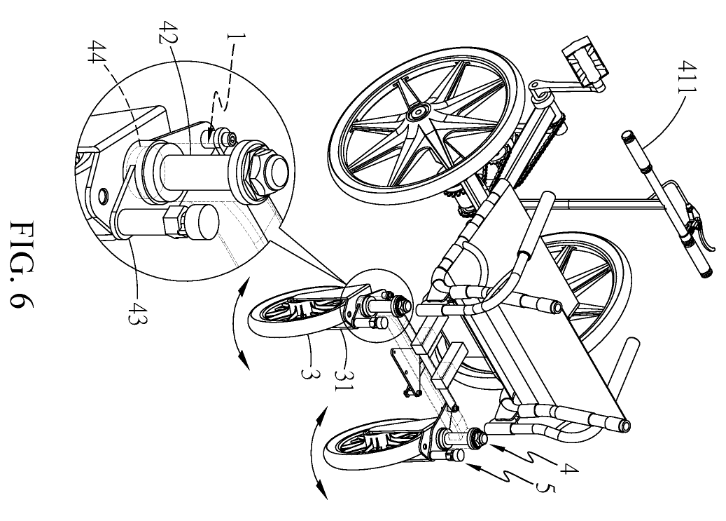

As shown in FIGS. 5-6, when the user uses the present invention for transportation or rehabilitation purposes, in principle, the user does not need to control the vehicle to move, and instead, a caregiver can push it from behind. Under this condition, it needs to change the switching assembly 5 to a free rotation mode so as to break the transmitting connection between the operating member 41 and the steering rear wheels 3, thereby allowing the steering rear wheels 3 to rotate freely and making it easy for the caregiver to push and move. As to the switching operation, it is mainly to release the state of engagement of the adjustment member 52 with the positioning portion 51 to have the adjustment member 52 separate from the positioning portion 51. As the protrusion portion 522 on the side of the adjustment member 52 is inserted in the deeper engagement notch portion 432, the caregiver has to resist the pulling force of the elastic element 521 to lift the adjustment member 52 upward and carry out rotation to move the protrusion portion 522 to a location above the shallower engagement notch portion 432, so that after the caregiver releases the adjustment member 52, the elastic element 521 naturally pull the adjustment member 52 down to insert into the shallower engagement notch portion 432. Since this engagement notch portion 432 is shallower, the top end of the adjustment member 52 will protrude out of the collar portion 431, that is, the bottom end of the adjustment member 52 will disengage and separate from the positioning portion 51, and due to such an effect of disengagement and separation, the connection member 43 cannot drive the protective cover 31 to move, thereby breaking the transmitting connection between the operating member 41 and the steering rear wheel 3. Further, since the second transmission axle 44 is only rotatably arranged at one side of the first transmission axle 42 and is not directly coupled to the first transmission axle 42, that is, in positional relationship, the second transmission axle 44 is pivoted to the connection member 43 or pivoted in the frame assembly 1, and in this way, the protective cover 31 and the steering rear wheel 3 become rotatable about a center defined by the second transmission axle 44 and can rotate and steer following the pushing by the caregiver, allowing the caregiver not necessarily to control the operating member 41 at the front side for steering and will not have difficulty in controlling the direction due to the steering rear wheel 3 being not able to rotate freely. As such, by using the design of the operation assembly 4 and the switching assembly 5, the steering rear wheel 3 is allowed to switch between the stem 411 control mode and the free rotation mode, thereby taking into account the control performance of riding and pushing, and the design of the collar portion 431 allows the adjustment member 52 to be stably disposed in the collar portion 431 regardless it is lifting or rotating, thereby ensuring the acting force of the elastic element 521 is more stable, avoiding excessive lateral force and accelerating fatigue, and also to have the adjustment member 52 firmly inserted in the positioning portion 51, or to have the protrusion portion 522 firmly inserted in the shallower engagement notch portion 432, thereby avoiding unexpected mode switching and also providing anti-collision protection, and extending the service life of the switching assembly 5. The design of the elastic element 521, the engagement notch portions 432, and the protrusion portion 522 helps simplify the operation of the switching assembly 5, reducing the problem of inaccurate engagement caused by improper human operation.

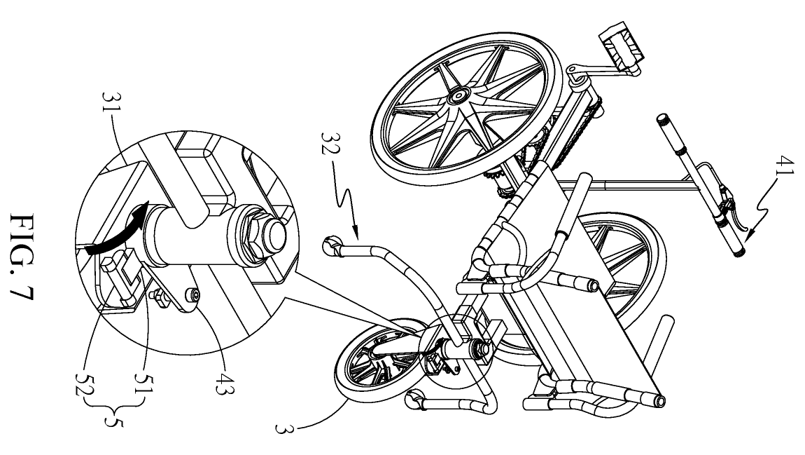

As shown in FIG. 7, the main difference of the instant embodiment from the previous embodiment resides in the structure and operation mode of the switching assembly 5, and the arrangement of the steering rear wheel 3 is changed to include just one single wheel, while auxiliary wheels 32 are arranged on two sides of the steering rear wheel 3 to prevent instability of the vehicle body caused by the arrangement of one single wheel for improving riding safety. As to the switching module 5, the positioning portion 51 is changed to a protruding block on one side of the connection member 43 as an example of illustration, and the adjustment member 52 is changed to a U-shaped buckle rotatably mounted on the protective cover 31 as an example of illustration, and the design of using the structures of the elastic element, the collar portion, the engagement notch portion, and the protrusion portion for mode switching is removed. As such, when the adjustment member 52 provided on the protective cover 31 is rotated to two sides of the positioning portion 51, the rotation of the connection member 43 is constrained by the adjustment member 52 due to the presence of the positioning portion 51, so as to synchronously rotate the adjustment member 52 and the protective cover 31, and driving the protective cover 31 to move is equivalent to driving the steering rear wheel 3 to move and similarly, the purpose of rear wheel steering by using the operating member 41 to the steering rear wheel 3 can be achieved. As to the switching assembly 5 being changed to the free rotation mode, it only needs to release the state of engagement of the adjustment member 52 with the positioning portion 51 to break the transmitting connection between the operating member 41 and the steering rear wheel 3, and similarly achieving the purpose of free rotation of the steering rear wheel 3. As such, the overall structure is made simpler and the manufacturing cost is reduced. This demonstrates that the structural relationship and the operation mode of the switching assembly 5 are not limited.

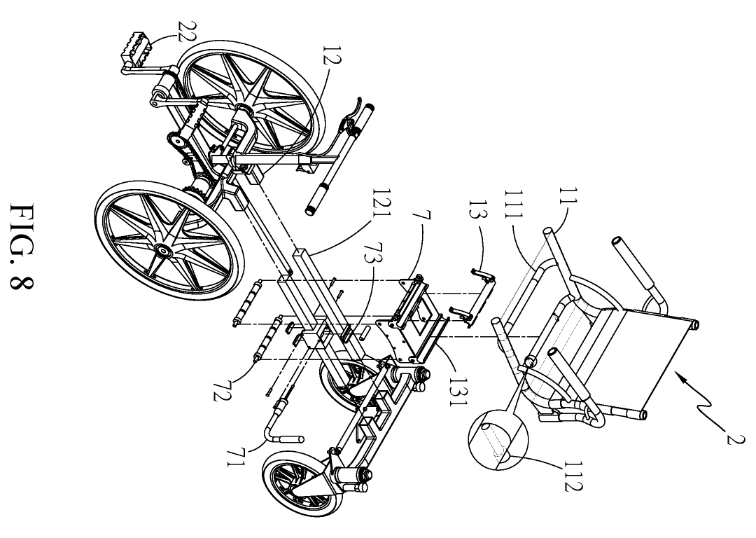

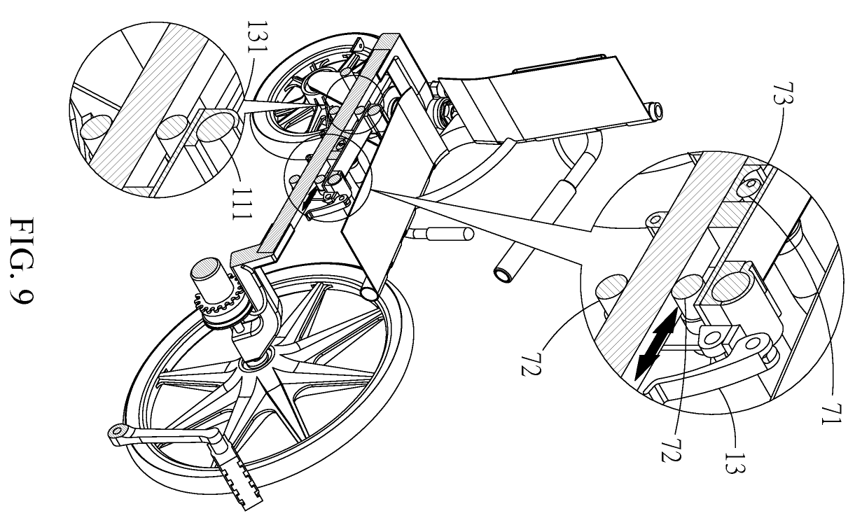

As shown in FIGS. 8-9, the main difference of the instant embodiment from the previous embodiment is adding the function that the seat element 2 is detachable and position adjustable, wherein the seat frame 11 is designed to be detachably mounted on the wheel frame 12, and the instant embodiment is implemented by arranging at least one quick release assembly 13 between the seat frame 11 and the wheel frame 12. Specifically, the quick release assembly 13 is a clip-type quick-release buckle arranged on the wheel frame 12 to enclose a bar 111 on the bottom of the seat frame 11 therein and to clamp and fix through tightening, so as to simply and quickly carry out quick disassembly and assembly of the seat frame 11, making it convenient for the user to separate the seat frame 11 and the wheel frame 12 when not in use in order to reduce the overall occupied space and facilitate storage. Or, it may further arrange at least one foolproof structure 112 between the seat frame 11 and the quick release assembly 13 to prevent the seat frame 11 from being installed in reverse or offset. In the instant embodiment, the foolproof structure 112 is provided as two screws arranged on the bottom of the seat frame 11 to correspond to two sides of the quick release assembly 13, wherein if the user does not install it properly, the foolproof structure 112 will collide with the quick release assembly 13, causing the seat frame 11 to be unable to be placed in the clamping seat 131 of the quick release assembly 13, so as to ensure correct installation during installation, and also to limit the quick release assembly 13 between the screws on the two sides, improving the axial position limiting effect of the quick release assembly 13 on the bar 111 of the seat frame 11 to indirectly increase the operation safety.

Further, the wheel frame 12 includes two slide rail portions 121, a fixation slide base 7 movably disposed on the slide rail portions 121 for mounting the seat frame 11, and a control member 71 for fixing the fixation slide base 7, wherein the fixation slide base 7 comprises two rollers 72 arranged on each of upper and lower sides of the slide rail portions 121, so as to provide a smooth sliding effect through the sliding mode of double rails and double rollers, and also to use the clamping effect of the upper-side and lower-side rollers 72 to prevent the fixation slide base 7 from deflecting or detaching. As an example of illustration, the control member 71 is an L-shaped bar. The control member 71 has one end located in the fixation slide base 7 and includes a slide-stopping portion 73 that increases the resisting force between the fixation slide base 7 and the slide rail portions 121. For example, the slide-stopping portion 73 can be a cam or an eccentric wheel on the end of the control member 71 or a colloid that can be pressed by the control member 71. When the control member 71 is pushed to have the end thereof rotating in the fixation slide base 7, the cam is caused to contact the slide rail portions 121, or the end of the control member 71 applies a downward pressing force to the slide-stopping portion 73. As such, the L-shaped design provides a larger torque to reduce the force required for the operation of fixing, and the slide-stopping portion 73 can easily provide a stronger resisting force to provide a simple and stable control effect. Furthermore, through the frontward and rearward adjustment function of the fixation slide base 7, the position of the seat element 2 can be adjusted according to the user’s body shape and leg length to a comfortable position for stepping on the drive pedal 22.

I claim:

1. A self-propelling vehicle for exercise, comprising:
a frame assembly;
a seat element, which is arranged on the frame assembly;
two moving front wheels, which are arranged on two sides of the seat element;
a drive pedal, which is connected to and drives each of the moving front wheels;
at least one steering rear wheel, which is arranged on one side of the frame assembly opposite to the drive pedal;
a protective cover, which is pivotally connected to a top of the steering rear wheel for steering in synchronization therewith;
an operation assembly, which is connected to the protective cover to operate the steering rear wheel to carry out change of a moving direction, wherein the operation assembly comprises an operating member controllable by a user, at least one first transmission axle pivotally disposed in the frame assembly, a connection member fixed on one end of the first transmission axle and drivable by the operating member, and a second transmission axle, wherein one end of the second transmission axle is pivotally arranged at one side of the first transmission axle, and another end is fixed to the protective cover; and
a switching assembly, which is arranged on one side of the connection member and comprises a positioning portion and an adjustment member corresponding to and engageable with the positioning portion, so as to have the second transmission axle and the first transmission axle rotating synchronously when engaging with the positioning portion and to have the second transmission axle rotating freely when disengaging from the positioning portion.

2. The self-propelling vehicle for exercise according to claim 1, wherein the adjustment member includes an elastic element arranged thereon to apply an elastic force to enhance the state of engagement of the positioning portion with the adjustment member, and includes, on one side of the connection member, a collar portion for mounting the adjustment member in a movable manner, wherein the collar portion includes two engagement notch portions, and the adjustment member includes a protrusion portion engageable with each of the engagement notch portions.

3. The self-propelling vehicle for exercise according to claim 1, wherein the frame assembly comprises a seat frame for mounting the seat element and a wheel frame for mounting each of the moving front wheels and the steering rear wheel, and the seat frame is detachably mounted to the wheel frame by means of at least one quick release assembly, and at least one foolproof structure is arranged between the seat frame and the quick release assembly.

4. The self-propelling vehicle for exercise according to claim 1, wherein the frame assembly comprises a seat frame for mounting the seat element and a wheel frame for mounting each of the moving front wheels and each steering rear wheel, and the wheel frame comprises two slide rail portions, a fixation slide base movably arranged on the slide rail portions for mounting the seat frame, and a control member for fixing the fixation slide base.
